(19) United States
(12) Patent Application Publication
(10) Pub. No.: US 2016/0247500 A1
(43) Pub. Date: Aug. 25, 2016

(54) CONTENT DELIVERY SYSTEM

(71) Applicant: Rory Ryder, Worcestershire (GB)

(72) Inventor: Rory Ryder, Worcestershire (GB)

(21) Appl. No.: 14/628,276

(22) Filed: Feb. 22, 2015

(51) Int. Cl. G10L 13/04; G10L 21/10; G06F 17/28; G06F 17/27; G06T 13/80

(52) U.S. Cl. CPC G10L 13/04; G06F 17/2705; G06T 13/80; G06F 17/289; G10L 21/10; G06T 2213/12

(57) ABSTRACT

A method of delivering content, the method comprising the steps of: receiving, at a user device, a data packet, wherein the data packet contains information relating to content to be delivered to the user; receive, by the user device, content based at least in part on the information in the data packet; parsing, by the user device, the content to identify textual content; inputting some or all of the extracted textual content to a text-to-speech synthesizer to generate audio and/or visual output; further inputting some or all of identified textual content into an animation unit which is configured to synchronize the generated output with one or more predetermined animation sequences to provide an output of an animated figure delivering the audio and/or visual output; displaying, at the user device the output of the animated figure delivering the audio and/or visual output.

### TECHNICAL FIELD OF INVENTION

The present invention relates to an apparatus and methodology for providing access to content, the content may be held on the internet, a local content store such as a database or server or a mobile user device such as a mobile phone.

### BACKGROUND TO THE INVENTION

As more information is made available to users over the internet, and the digest of information is becoming more prevalent through user devices, the ability of a user to consume content has changed.

Information for a user may not always be presented to the user in the most effective way. It also may not be suitable for a user nor is it necessarily presented in an easy to understand manner. Many internet users are children who are unable, or have difficulty in reading and typing. Similarly, some internet users are visually impaired and cannot view a screen or display for an extended period of time.

It is known to use a text-to-speech systems to read text stored on the internet. However, such systems require the user to input the text manually and typically require long complicated key strokes or sequences to achieve the desired result.

There is a need to provide a more efficient man-machine interface which allows users to access and be presented with content in an effective, simple to use, manner.

According, the present invention provides a method of delivering content, the method comprising the steps of receiving, at a user device, a data packet, wherein the data packet contains information relating to content to be delivered to the user; receive, by the user device, content based at least in part on the information in the data packet; parsing, by the user device, the content to identify textual content; inputting some or all of the extracted textual content to a text-to-speech synthesizer to generate an audio output; further inputting some or all of identified textual content into an animation unit which is configured to synchronize the generated audio output with one or more predetermined animation sequences to provide an audio and/or visual output of an animated figure delivering the audio output; displaying, at the user device the output of the animated figure reading the extracted textual content.

Other aspects of the invention will become apparent from the appended claim set.

### BRIEF DESCRIPTION OF THE DRAWINGS

Embodiments of the invention are now described, by way of example only, with reference to the accompanying drawings in which:

FIG. 1 is a flow chart of the process according to an aspect of the invention;

FIG. 2A shows an example of a robot;

FIG. 2B shows a further example of a robot;

FIG. 2C shows an example of the animated robot delivering content; and

FIG. 2D shows an example of the options available to the end user in the sharing widget.

FIG. 3A shows an example of the animated robot delivering content, and

FIG. 3B shows a view of a mobile device screen of a robot doing a variety of tasks and asking a question

FIG. 3C shows a view of a mobile device screen of another robot reading from a book.

### DESCRIPTION OF AN EMBODIMENT OF THE INVENTION

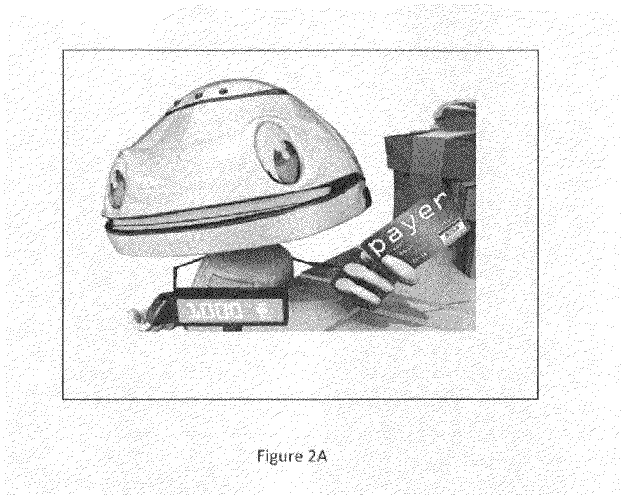

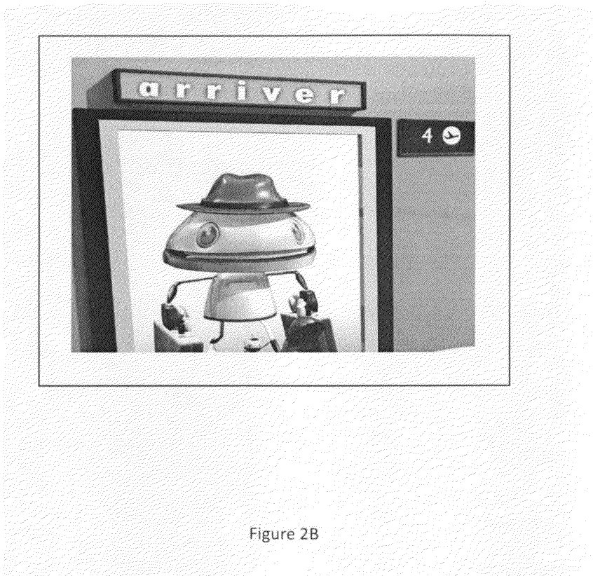

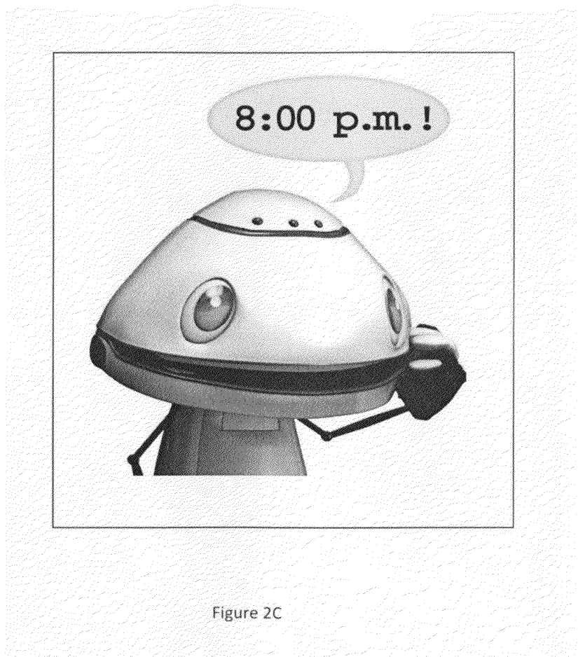

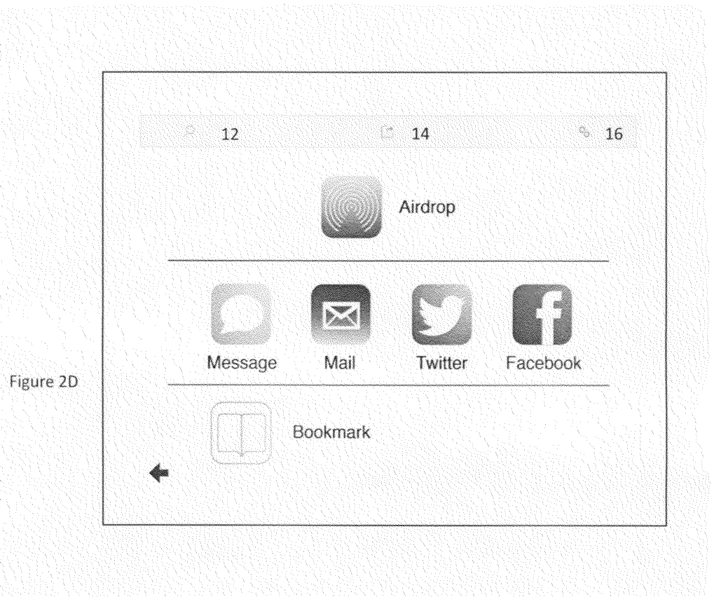

There is provided a content delivery system in the form of a personal assistant, which is able to assimilate content intended for delivery or presentation to a user, identify animation data and audio data and deliver the results to the end user via an animated figure (such as that shown in FIG. 2). The animation figure is not necessarily human-like or has human features and dimensions. The animations are synchronized with audio output in order to provide the end user with the visual effect that the animated figure is delivering/speaking (and can be animated to show he is reading whilst speaking) content.

Optionally, in order to improve the end user's interaction with the animated figure, text extracted from content intended for delivery to the user is synchronously presented as the animated figure “speaks” the text. In a particular embodiment of the invention, the animated figure is a robot which is reading a book. As the text is spoken the robot is animated so as to present the illusion that the robot is reading the text from the book. The movement of the robot, eyes, mouth, facial expressions etc., are synchronized with the audio output so as to create an interactive experience for the end user. It is found that such an experience, a kinesthetic experience, aides a user's understanding of the information presented therefore providing a more efficient interface for the user to assimilate the information.

The present invention may be used to present audio and animated information in response to the receipt of a beacon signal. Beacons are devices which periodically transmit data packets which can be received by devices within a particular range of the beacon. Beacons have various different uses within public or private spaces such as in shops, bars, restaurants, airports, museums, hotels, public transport, etc. For example, in a retail environment, information transmitted by a beacon and received by a user's phone can allow the user's phone, either manually or automatically, to retrieve discounts, offers, pricing information, etc via a particular application or program on the user's device.

Users can opt in to receive information following receipt of a beacon signal and can also opt out of receiving beacon information from other beacons that are within the same area—allowing the person to not be overloaded with offers. Beacon signals can be received by a user device provided the user device has the requisite application or software installed which can receive the beacon signal.

The invention, in some embodiments, allows the user to use the content and integrate the content with other functionality present in a user's device. For example when the invention is executed on a smartphone, tablet computer, desktop computer, laptop or wearable device if a content contains contact information, such as a telephone number or VOIP address, the invention identifies the contact information and initiates contact. In an embodiment the invention launches a VOIP program, such as Skype, to initiate a call. In further embodiments where the content returns an address the invention opens up a web mapping service application or program, and uses the information to display the location. Preferably, the invention also interacts with the web mapping service and known location determining means (such as GPS) which are present, in say a wearable smart device, smartphone, tablet computer etc., to provide direction information.

Therefore the present invention provides the user with an interactive experience through which they can receive content, held on a number of sources such as the internet. Since the beacons can also be received by the user even if the user's device is not connected to the internet, they can be used to trigger the delivery of information or notifications when the user is next connected to the internet. Additionally, the user can receive content via a Bluetooth connection with a local bluetooth device. Advantageously, such a system may be used by the visual impaired and/or those who cannot, or have difficulty, in reading or writing. Furthermore, by having the animated figure delivering the results of the content the end user's experience is improved as they can further engage with the animated figure.

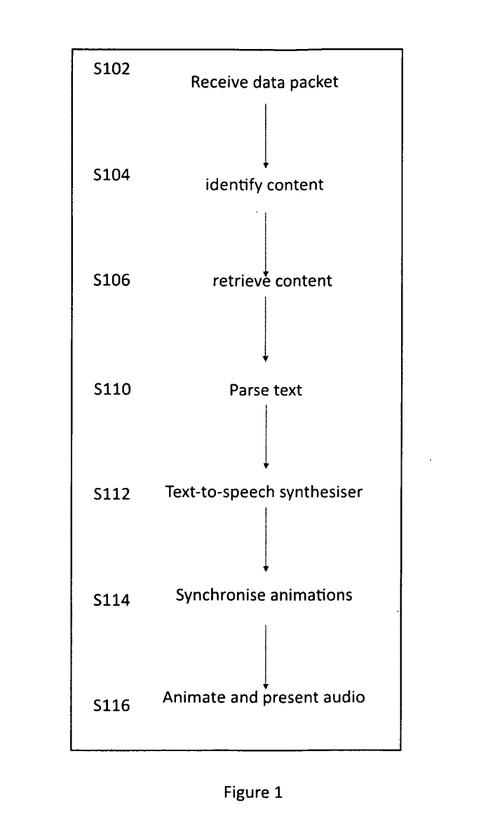

FIG. 1 is a flowchart describing the process of an end user utilizing the content delivery system of the present invention.

At step S102, the user receives a data packet from a beacon. The data packet identifies content or information which is subsequently presented to the user in an efficient, interactive, manner. For ease of illustration, the following process is described with respect to a smartphone or tablet computer device, though the invention described herein may equally be applicable to other computing devices such as laptops and smart watches etc.

At step S104, the data packet is analyzed by the user's device to identify information which indicates content to the delivered to the user. For example, the data packet may specify information held on a server relating to a retail store, and the content includes details of a particular offer. In one embodiment, the user's device launches an application or program based on the information contained in the data packet. It is via this information that the details of a particular offer are presented by an animatronic robot (specific to a particular application), as will be described below. Alternatively, the presentation of the content is via a ‘default’ application (using a single animatronic robot) which is capable of being used in conjunction with various different types of content delivery via different beacons.

As step S106, the content is retrieved by the user's device. This may be achieved via any suitable data transmission means. For example, if a user is in a retail store and has a cellular network connection, information concerning a particular retail offer, as specified in the data packet received from a beacon located in the store, will be retrieved over the internet via a cellular data network connection and provided to the relevant application. However, if not connected to the internet, the user could still receive information via bluetooth, for example, sent from a store's local bluetooth device or server.

At step S110, the offer information retrieved from the internet is parsed to extract text information. For example, offer information retrieved may contain non-text information, such as images or video. For the purposes of the present invention, non-text information is unnecessary. The text information may include instructions concerning, or indicate, a particular expression, such as a smile, or a gesticulation such as waving hands to be output by the animatronic robot, as discussed in further detail below. Additionally or alternatively, the content may comprise an instruction for the animation of a particular action (for example, pouring coffee). Such an action would be whole or part of a predetermined animation sequence.

At step S112, some or all of the parsed text is sent to a text-to-speech synthesizer in order to generate an audio output and/or visual output of the parsed text. Such text-to-speech synthesizers and TTS synthesizers for emotional expressivity are known in the art.

At step S114 the text which was sent to text-to-speech synthesizer at step S112 is analyzed by an animation synchronization module. In order to provide an improved end user experience, it is desirable that the animated figure presenting the audio output is animated in such a manner that the motion of the figure is synchronous with the text in order to provide the impression that the text is being spoken by the animated figure. Therefore, it is desirable that the animations relating to the movement of the mouth of the animated figure of synchronous with the spoken text. In further examples the animated figure may be animated so as to provide the impression that the figure is reading the text from a textbook, or the like, accordingly the movement of the eyes of the animated figure are also consistent with the eye movement of the figure reading the text.

Additionally, the text of the output may also be presented on a screen at the same time as the audio output, in a manner similar to subtitles, and the animation synchronization unit ensures that the text presented on the screen is the same as the text which is currently being read out by the animated figure.

To ensure the animations remain consistent the language structure of the text (number of words, syllables, punctuation etc.) submitted to the animation synchronization unit is used to determine an optimal animation sequence for the text. For example, a specific sequences of syllables may be associated with a set animation sequence of the figure's mouth.

At step S116 the animated figure is synchronized with the audio output from the text to speech synthesizer and provides the end user with a visual and audio output of the results of the search query.

The combination of movement in their mouth, eyes, head, body etc combined with emotional TTS technology means that the robot can engage and connect with people in a way that text and pictures fail to do. Furthermore the robot can provide the user with the visual impression that the user is either near or far away from a beacon signal by visibly changing its color, expression and/or character; this creates a more engaging and helpful indication of how near the user is to a beacon (for example) if the user is on the far region of a beacon signal the robot can change its color to blue whilst also making the action of shivering indicating to the user that the user is far away from the beacon. Similarly the robot can change from the action of shivering to an action indicating the robot is hot once in the immediate region of the beacon; this can be further demonstrated to the user by the robot changing color progressively from blue indicating (far region) to orange indication (near region) to red indicating (immediate region); far, near and immediate regions are known to describe beacons three tiers of proximity.

In some embodiments, the robots can interact vocally (i.e. without showing any information) or they can (when asked) show an offer (text or pictures) if the user request—this can then immediately be shown on the user's smart watch, device or external screen—this can be done by voice command or by simply clicking YES or NO on the screen.

A user can turn the robot off via settings for an application and opt to have the standard delivery of offers or information but at any time can reopen their robot to deliver offers or information verbally by the robot. Additionally, users can customize their beacon bots to remember their likes and dislikes so the robots become more in tune with their users taste.

Advantageously, therefore the present invention provides an improved methodology with which to present information to the end user. The information presented, in an embodiment, is the most relevant information for the user, who has selected to receive content based on information received in beacons. Furthermore, the user has the ability to have certain audio content spoken in one of a multiple languages. Optionally, the text of the spoken results is scrolled on the screen synchronously with the spoken output. Optionally, the audio output (i.e. the spoken text) and the scrolled text may be in the same or different languages. In examples where the text and spoken output are in the same language this aides the end user's comprehension of the text as well as helping them learn the correct spelling and pronunciation of words. Where the text and audio output are different languages the end user is able to use the different outputs to learn new vocabulary as well as confirm their understanding of the output. Preferably, there is a simple toggle option presented to the user to turn the subtitles on or off, thereby allowing the delivery of the results to continue without interruption.

Advantageously, the animated figure may also be paused whilst reading the results. Preferably, to increase the end user's interaction with the figure the figure is animated to indicate a pause or sleeping state. Similarly, when the process is resumed the figure is animated to provide the end user with the impression that the figure has been awoken. Such animations provide an improved user interactions and an improved end user experience.

Therefore, the present invention provides efficient and effective delivery of content. By allowing the content to be presented to the end user in such a manner the user's ability to assimilate the information is improved thus providing a more efficient man-machine interface.

FIG. 2A is an example of the invention in use.

FIG. 2A shows an example of a robot indicating to the user, for example, that payment confirmation from the user is required. Built in secured payments allows the robot to take payments by voice commands.

There is shown in FIG. 2B the animated figure,arriving at an airport after a flight. This could be used in conjunction with, for example, text indicating where, for example, the location of the nearest taxi rank is.

FIG. 2C is a further example of an animated robot to convey to the user when a promotion in a bar begins.

The robot's eyes and mouth are animated during the audio delivery to provide the impression that the robot is reading text from, for example, textbook, note, wall, sign, etc and reading the information out loud. In use if the user interacts with the animated figure, for example via tap gesture or mouse click depending on the end user's device, the animated figure will pause. Preferably, the animated figure is animated to indicate that it has paused, thus improving the interactive element of the invention.

FIG. 2D shows the options available to the end user in the sharing widget, for example, for sharing the application. The end user is presented with options to share or “post” a link to the animated figure reading on a social media website.

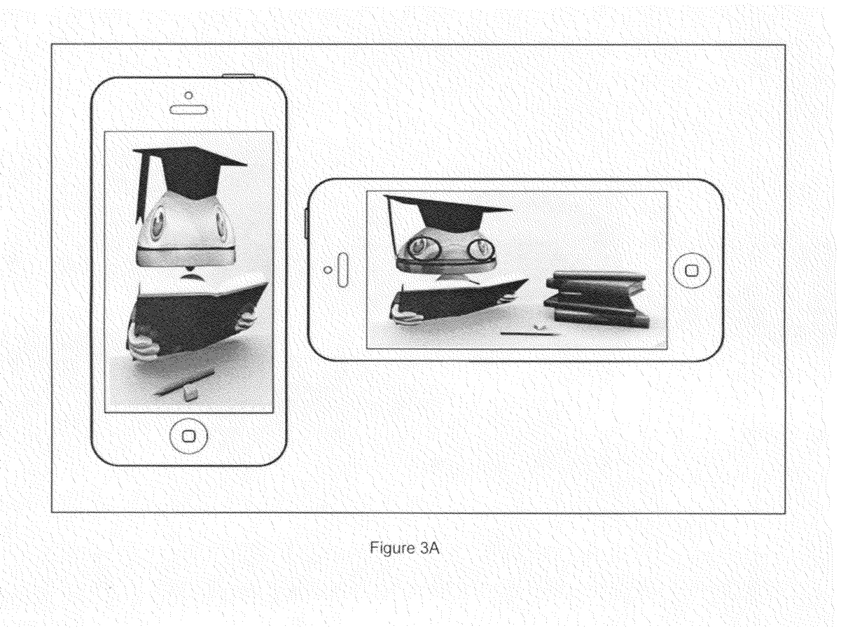

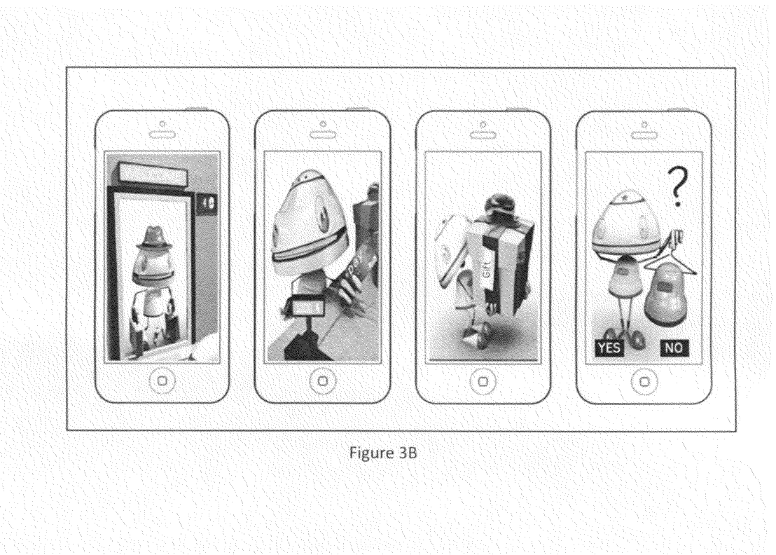

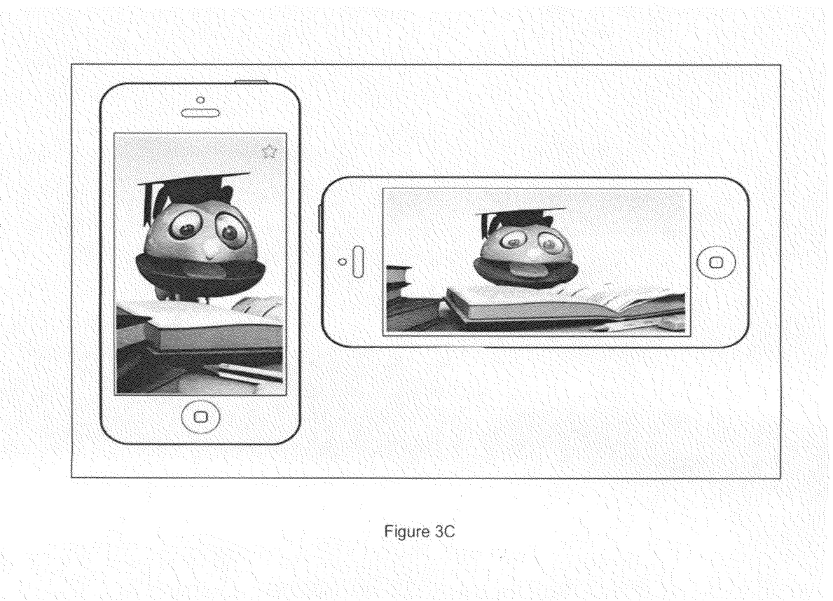

FIGS. 3A-3C show view of an animatronic robot in a mobile device screen.

Therefore the present invention provides an improved end user experience in which they can interact with the animated figure in a fun and effective manner. The mixture of audio and visual output also helps the end user with comprehension of the text, aide in learning a new language, as well as be fully accessible to young, the hard of seeing or hearing, and those with difficulty with reading and/or writing. It is beneficially found that the use of the animated figure also improves user interactivity providing a more personal experience for the user, ultimately aiding their comprehension and reception of the information presented.

The invention takes the form of a software module, or app, which is installed onto a computing device. The device has a processor for executing the invention, with a display and a user input. The computing device may be one of a smartphone, tablet computer, laptop, desktop or wearable computer such as a smart watch device, or a device with an optical head-mounted display. Such devices contain the display and user input which the invention utilizes as well as having other existing functionality with which the invention may interact (as per step S116 of FIG. 1). Such functionality includes the ability to make telephone calls (such as via VOIP or a mobile telephone network), email clients, mapping services etc.

1. A method of delivering content, the method comprising the steps of:
receiving, at a user device, a data packet, wherein the data packet contains information relating to content to be delivered to the user;
receive, by the user device, content based at least in part on the information in the data packet;
parsing, by the user device, the content to identify textual content;
inputting some or all of the extracted textual content to a text-to-speech synthesizer to generate audio and/or visual output;
further inputting some or all of identified textual content into an animation unit which is configured to synchronize the generated output with one or more predetermined animation sequences to provide an output of an animated figure delivering the audio and/or visual output;
displaying, at the user device the output of the animated figure delivering the audio and/or visual output.

2. The method of claim 1, wherein the data packet is received from a beacon.

3. The method of claim 1, wherein the data packet is received only when the user device is in range of the beacon.

4. The method of claim 1, wherein the content is stored remotely from the user device.

5. The method of claim 1, wherein the content is web-based.

6. The method of claim 1 wherein the end user is able to select a language in which the content is delivered.

7. The method of claim 6 wherein the text-to-speech synthesizer is chosen to match the selected language.

8. The method of claim 1 wherein the animated figure is a robot.

9. The method of claim 8 wherein the robot is reading a book.

10. The method of claim 8 wherein the animation sequences include animating the eyes and mouth of the robot.

11. The method of claim 1, wherein the content is stored on a separate user device.

12. The method of claim 11 wherein an animation is shown to represent that the animated figure has entered a pause or sleep mode.

13. The method of claim 1 wherein the search results are parsed to identify contact information, and presenting on the display the option to use the contact information, wherein the contact information is a telephone number or VOIP ID, and the method comprises the steps of opening a communication application and calling the identified number or ID.

14. The method of claim 1 wherein the content is analyzed to identify location information, and the method further comprises presenting on the display the option to use the location information in a web mapping service application.

15. A computing device, having a processor, a display and a user input, wherein the processor is configured to perform the steps of:
receiving, at a user device, a data packet, wherein the data packet identifies content to be delivered to the user;
retrieve, by the user device, the content to be delivered to the user;
parsing, by the user device, the content to identify textual content;
inputting some or all of the extracted textual content to a text-to-speech synthesizer to generate audio and/or expressive visual output;
further inputting some or all of identified textual content into an animation unit which is configured to synchronize the generated output with one or more predetermined animation sequences to provide an output of an animated figure delivering the audio and/or expressive visual output;
displaying, at the user device the output of the animated figure delivering the audio and/or expressive visual output.

16. The computing device of claim 15 wherein the device is one of the group comprising: a smartphone, laptop computer, tablet computer, or wearable computing device.
